(19) United States
(12) Patent Application Publication
(10) Pub. No.: US 2022/0363983 A1
(43) Pub. Date: Nov. 17, 2022

(54) STABLE NON-AQUEOUS SUSPENSIONS OF WATER-SOLUBLE POLYSACCHARIDES, AND METHODS FOR TREATING OIL AND/OR GAS WELLS WITH A FRACTURING FLUID COMPRISING SUCH AND WATER

(71) Applicant: FIREREIN INC., Napanee (CA)

(72) Inventors: Zackery Michael HODGEN, Napanee (CA); David HYNDMAN, Napanee (CA)

(21) Appl. No.: 17/766,037

(22) PCT Filed: Oct. 6, 2020
(86) PCT No.: PCT/CA2020/051338

§ 371 Date: Apr. 1, 2022

Related U.S. Application Data
(60) Provisional application No. 62/911,639, filed on Oct. 7, 2019.

(51) Int. Cl. C09K 8/90

(52) U.S. Cl. CPC C09K 8/905; C09K 2208/28

(57) ABSTRACT

Provided herein are friction reducers comprising a thickening agent, a liquid medium, and a stabilizing agent; and methods and uses thereof for the treatment of an oil and/or gas well having a wellbore.

### FIELD

The present application relates generally to methods and compositions for treating an oil and/or gas well having a wellbore.

### BACKGROUND

In order to reach a formation containing petroleum and/or natural gas, a wellbore is drilled in successive sections through the rock layers. Once the desired length of each wellbore section has been drilled, the drilling assembly is removed, and steel casing is inserted and cemented in place. As the wellbore is constructed, concentric layers of steel casing and cement form the barrier to protect groundwater resources from the contents that will later flow inside the wellbore. Next, only the section of casing within the formation is perforated at the desired location.

The wellbore is now ready for hydraulic fracturing, which is a technique used to stimulate hydrocarbon production by creating a network of highly conductive fractures in the area surrounding a wellbore. The network of fractures created not only improves hydraulic conductivity of a reservoir rock but also increases the surface area contributing to hydrocarbon production. To create fractures in a reservoir rock, a fracturing fluid is injected under high pressure to hydraulically crack the rock open. Once the reservoir rock is cracked, the fracturing fluid enters the cracks and starts propagating fractures away from the wellbore. Another important function of the fracturing fluid is to carry and transport proppants into the fractures. Proppants physically separate fracture faces to keep the fractures open at the end of the fracturing process, creating pathways for petroleum, natural gas, and fracturing fluids to flow more easily to the wellbore.

After hydraulic fracturing, a plug is set inside the casing to isolate the stimulated section of the wellbore. The entire perforate—inject—plug cycle is then repeated at regular intervals along the targeted section of the reservoir. Finally, the plugs are drilled out, allowing the petroleum, natural gas, produced waters (i.e., water naturally occurring in the formation), and fracturing fluids (known as flowback water in this context) to flow into the well casing and up to the surface. This fluid mixture is separated at the surface, and the flowback and produced waters are captured in tanks or lined pits. The flowback and produced waters are then disposed of according to government-approved methods, or in some cases cleaned and reused. Hydraulic fracturing operations generally occur over a 3-5 day period.

Hydraulic fracturing is usually done using water-based fracturing fluids. Water-based fracturing fluids include crosslinked gels, linear gels, and slickwaters. Linear gels comprise a polymeric gelling agent such as guar gum, xanthan gum, hydroxypropylcellulose or hydroxyethylcellulose. The viscosity of a linear gel is dependent on the concentration of gelling agent but is generally between 10 and 100 cP.

Crosslinked gels comprise similar gelling agents as linear gels, but contain one or more crosslinking agents such as borate, titanium, zirconium, and aluminum compounds, which may result in an increased viscosity of 100-1000 cP. The increased viscosity may result in improved proppant transport capability and increased fracture width compared to linear gels.

Both linear and crosslinked gels form solid residues on fracture surfaces known as filter cake, which impair the fluid conductivity of the fractures. The more viscous crosslinked gels are more prone to filter cake formation. To restore high fluid conductivity, the viscous fluids and the filter cake must be degraded with a breaker, which is typically an oxidizing or enzymatic agent. Degrading the fracturing fluids with the breaker also prevents the flowback water from carrying the proppant back to the surface.

In contrast to linear and crosslinked gel fracturing fluids, a slickwater is a low-viscosity aqueous fracturing fluid containing a low concentration of a friction reducer. A friction reducer is a polymer-containing component that reduces the flow friction of a fracturing fluid, thereby lowering the pumping pressure required to deliver the fracturing fluid and allowing the fracturing fluid to be injected more rapidly through a wellbore and into the formation.

There exists a need for the development of improved and/or alternative methods and compositions for fracturing.

### SUMMARY

In one aspect, there is provided a method of treating an oil and/or gas well having a wellbore, comprising combining a friction reducer with water or an aqueous solution to form a fracturing fluid, and delivering the fracturing fluid into the wellbore. The friction reducer comprises: 10-75 wt % of a thickening agent; 15-90 wt % of a liquid medium; and a stabilizing agent, wherein the friction reducer does not comprise polyacrylamide or a derivative thereof.

In an embodiment of the method as described herein, the friction reducer consists of >75%, >80%, >85%, >90%, >95%, >98% or 100% by weight consumer-grade components.

In an embodiment of the method as described herein, the thickening agent is a biopolymeric thickening agent.

In an embodiment of the method as described herein, the thickening agent comprises a gum, a starch, or a combination of a gum and a starch.

In an embodiment of the method as described herein, the combining step takes place on a fracturing site.

In an embodiment of the method as described herein, the water is untreated.

In an embodiment of the method as described herein, the fracturing fluid is a slickwater.

In another aspect, there is provided a friction reducer comprising: 10-75 wt % of a thickening agent, 15-90 wt % of a liquid medium, 0.5-20 wt % of a first surfactant, and a stabilizing agent.

In an embodiment of the friction reducer as described herein, the friction reducer does not comprise polyacrylamide or a derivative thereof.

In an embodiment of the friction reducer as described herein, the thickening agent is a biopolymeric thickening agent.

In an embodiment of the friction reducer as described herein, the friction reducer does not comprise a viscosifier that is not the thickening agent.

In an embodiment of the friction reducer as described herein, the friction reducer consists of >75%, >80%, >85%, >90%, >95%, >98% or 100% by weight consumer-grade components.

In an embodiment of the friction reducer as described herein, the thickening agent comprises a gum, a starch, or a combination of a gum and a starch.

In an embodiment of the friction reducer as described herein, the first surfactant has an HLB value of at least 10.

In an embodiment of the friction reducer as described herein, the friction reducer further comprises 0.5-20 wt % of a second surfactant, wherein the second surfactant optionally has an HLB value of less than 10.

In an embodiment of the friction reducer as described herein, the stabilizing agent is selected from the group consisting of silica, glycogen, bentonite, C18 or longer hydrocarbons, C12 or longer fatty acids and their derivatives, and any combination thereof.

In another aspect, there is provided a friction reducer comprising: 10-75 wt % of a thickening agent, 15-90 wt % of a liquid medium, 0.5-20 wt % of an elastomer, and a stabilizing agent.

In an embodiment of the friction reducer as described herein, the friction reducer does not comprise polyacrylamide or a derivative thereof.

In an embodiment of the friction reducer as described herein, the thickening agent is a biopolymeric thickening agent.

In an embodiment of the friction reducer as described herein, the friction reducer does not comprise a viscosifier that is not the thickening agent.

### DETAILED DESCRIPTION

It has been surprisingly discovered by the present inventors that blends of consumer-grade components disclosed herein may be more environmentally friendly for use as friction reducers in oil and/or gas wells than polyacrylamide-based friction reducers. In some embodiments, friction reducers provided herein exhibit physical characteristics comparable to polyacrylamide-based friction reducers, while also offering good shear stability at pumping pressures up to 3000 psi. In some embodiments, friction reducers provided herein are less sensitive to water hardness or salt concentration than polyacrylamide-based counterparts, thus making it possible to form fracturing fluids using untreated water or flowback. In some embodiments, by omitting polyacrylamide and using nontoxic consumer-grade components, friction reducers provided herein obviate the need to decontaminate acrylamide-containing fracturing fluid.

In some embodiments, friction reducers provided herein consist of >75%, >80%, >85%, >90%, >95%, >98% or 100% by weight non-toxic, consumer-grade components. In some embodiments, the consumer-grade components are also biodegradable, renewable and/or naturally-sourced.

As used herein, the term “non-toxic” is meant to mean non-poisonous, non-hazardous, not composed of poisonous materials that could harm human health if exposure is limited to moderate quantities and not ingested. Non-toxic is meant to connote harmlessness to humans and animals in acceptable quantities if not ingested and even upon ingestion, does not cause immediate serious harmful effects to the person or animal ingesting the substance. The term non-toxic is not meant to mean able to be swallowed or injected or otherwise taken in by animals, plants, or other living organisms. The term non-toxic may mean the substance is classified as non-toxic by the Environmental Protection Agency (EPA), the World Health Organization (WHO), the Food and Drug Administration (FDA; e.g., designated as Generally Recognised as Safe (GRAS)), the United States Department of Agriculture (USDA), Health Canada, or the like. The term non-toxic is therefore not meant to mean non-irritant or not causing irritation when exposed to skin over prolonged periods of time or otherwise ingested.

As used herein, the term “consumer-grade components” refers to food-grade, personal care-grade, and/or pharmaceutical-grade components. The term “food-grade” is used herein to refer to materials safe for use in food, such that ingestion does not, on the basis of the scientific evidence available, pose a safety risk to the health of the consumer. The term “personal care-grade” is used herein to refer to materials safe for use in topical application such that topical application does not, on the basis of the scientific evidence available, pose a safety risk to the health of the consumer. The term “pharmaceutical-grade” is used herein to refer to materials safe for use in a pharmaceutical product administered by the appropriate route of administration, such that administration does not, on the basis of the scientific evidence available, pose a safety risk to the health of the consumer.

In some embodiments, friction reducers provided herein do not comprise polyacrylamide or a derivative thereof. As used herein, a derivative of polyacrylamide includes any copolymer of acrylamide with any other olefin-containing monomer, and any polymer that can be obtained through chemical reactions of polyacrylamide.

An embodiment of the present disclosure thus provides a method of treating an oil and/or gas well having a wellbore, comprising:

combining a friction reducer with water or an aqueous solution to form a fracturing fluid, and

delivering the fracturing fluid into the wellbore,

wherein the friction reducer comprises:

a. 10-75 wt % of a biopolymeric thickening agent;

b. 15-90 wt % of a liquid medium; and

c. a stabilizing agent,

wherein the friction reducer does not comprise polyacrylamide or a derivative thereof.

Another embodiment of the present disclosure provides a friction reducer comprising: 10-75 wt % of a biopolymeric thickening agent, 15-90 wt % of a liquid medium, 0.5-20 wt % of a surfactant and/or an elastomer, and a stabilizing agent.

A further embodiment of the present disclosure provides a fracturing fluid comprising 0.01-10 wt % of a friction reducer provided herein and water or an aqueous solution to make up 100 wt %.

Friction Reducers and Their Components

Friction reducers provided herein comprise at least a thickening agent, a liquid medium, and a stabilizing agent. Friction reducers provided herein may further comprise a surfactant, an elastomer, or both. Friction reducers provided herein may also further comprise additional additives.

Thickening Agents

Friction reducers described herein comprise at least one thickening agent. A thickening agent may be a biopolymeric thickening agent or a non-biopolymeric thickening agent. As used herein, the term “biopolymer” refers to a polymeric substance occurring in living organisms (e.g., animals, plants, algae, and bacteria) while the term “biopolymeric” describes a substance that is a biopolymer.

Within the context of the present application, suitable thickening agents are selected to provide properties effective for reducing friction in fracturing fluids. For example, suitable thickening agents may help to maintain laminar flow of a fracturing fluid by reducing interfacial tension between the fracturing fluid and the contact surface, or by preventing turbulent vortices in the fracturing fluid. However, turbulent flow regimes may nevertheless be produced at the pumping rates typical of slickwater fracturing in the presence of friction reducers. Under this scenario, it is expected that polymer elongation may serve to dampen the vortices characteristic of turbulent flow, thereby decreasing the flow friction.

In some embodiments, thickening agents suitable for use in friction reducers provided herein are capable of modifying the viscosity of fracturing fluids formed therefrom such that the fracturing fluids can sufficiently carry proppants without an additional viscosifier. Accordingly, in some embodiments, friction reducers provided herein do not comprise a viscosifier that is not the thickening agent.

In some embodiments, thickening agents suitable for use in friction reducers provided herein are capable of imparting shear thinning properties to fracturing fluids formed therefrom. Shear thinning is a characteristic of some non-Newtonian fluids in which the fluid viscosity decreases with increasing shear rate.

Certain polysaccharides can function as biopolymeric thickening agents. Polysaccharide thickening agents include, but are not limited to, starches, natural gums, alginates (such as sodium alginate), chitins, chitosans, celluloses (such as carboxymethylcellulose sodium salt), glycogens, pectins, carrageenans, or agars.

In some embodiments, the at least one thickening agent may comprise starch. Starch, which is a biodegradable, naturally-sourced polymer, can form gels in the presence of water and heat. Examples of starches that are viable for use in friction reducers described herein include, but are not limited to, corn starch, wheat starch, arrowroot, potato starch, tapioca, and/or rice starch, or consumer-grade derivatives thereof, which may or may not be naturally sourced. Starches can be modified by cross-linking, pregelatinizing, hydrolysis, acid/base-treating, or heating to modify their structure, leading to alteration of their solubility, swelling, viscosity in solution, or stability.

In some embodiments, the at least one thickening agent may comprise a natural gum. Viable, naturally sourced natural gums include, but are not limited to, guar gum, xanthan gum, acacia gum (gum arabic), diutan gum, welan gum, gellan gum, and/or locust bean gum, some of which are used as thickeners in food, pharmaceutical and/or cosmetic industries. Polysaccharide gums are polymers of various monosaccharides with multiple branching structures that cause a large increase in the viscosity of a solution. For example, guar gum is a branched polymer of a linear mannose polymer with galactose side-branches, sourced primarily from ground endosperms of guar beans, and reportedly has a greater water-thickening potency than cornstarch; xanthan gum is produced by Xanthomonas campestris [Tako, M. et al. Carbohydrate Research, 138 (1985) 207-213]; and acacia gum is a branched polymer of arabinose and galactose monosaccharides.

In some embodiments, the thickening agent comprises more than one polysaccharide, such as two, three, or four polysaccharides. In one embodiment, the at least one thickening agent comprises a blend of a starch and at least one natural gum. In another embodiment, the at least one biopolymeric thickening agent comprises a blend of a starch, xanthan gum and guar gum. The present inventors have found that such blends possess good shear stability at pumping pressures up to 3000 psi. Without being limited by any particular theory, it is expected that such blends may be more stable under high shear compared to each component on its own.

Certain proteins may also function as thickening agents. In some embodiments, the at least one thickening agent comprises a protein. Protein thickening agents include, but are not limited to, collagen, gelatin, gluten, soy proteins and milk proteins.

The overall concentration of the thickening agent(s) in a friction reducer provided herein may be in the range of from about 10% to about 75%, by weight, from about 25% to about 75%, by weight, from about 30% to about 65%, by weight, from about 30% to about 60%, by weight, from about 30% to about 50%, by weight, or from about 30% to about 40%, by weight. In some embodiments, the overall concentration of the thickening agent in a friction reducer provided herein is about 10%, by weight, about 15%, by weight, about 20%, by weight, about 25%, by weight, about 30%, by weight, about 35%, by weight, about 40%, by weight, about 45%, by weight, about 50%, by weight, about 55%, by weight, about 60%, by weight, about 65%, by weight, about 70%, by weight, or about 75%, by weight.

Liquid Mediums

In some embodiments, friction reducers provided herein are suspensions. Without being limited by any particular theory, it is expected that suspending the components of a friction reducer in a liquid medium facilitates its mixing with water, and potentially increases the rate and/or ease at which a fracturing fluid provided herein is formed. In some embodiments, the liquid medium is an edible oil, castor bean oil, pine tree sap, petroleum distillate, mineral oil, glycerol, and low-molecular weight polyethylene glycol (PEG), or a combination thereof.

Examples of non-toxic, consumer-grade liquid mediums include, but are not limited to, edible oils (such as nut/seed oils, or vegetable/plant oils), glycerol, and low-molecular weight polyethylene glycol (PEG), with or without a small amount of water (for example, 5% or less, by weight, or from about 1% to about 3% by weight).

In addition to being naturally-sourced and/or food-grade, liquid mediums such as vegetable oil, glycerol, and PEG resist freezing at sub-zero temperatures; thus, friction reducers formed with such liquid mediums can maintain their utility for forming fracturing fluids under winter and/or arctic conditions. Further, some liquid mediums, such as glycerol and PEG, are water-miscible, which may also enhance the ability of a friction reducer to efficiently mix with water and form a fracturing fluid.

In some embodiments, the liquid medium comprises canola oil. In some embodiments, the liquid medium comprises linseed oil. In some embodiments, a friction reducer comprises a mixture of more than one liquid medium.

The overall concentration of the liquid medium in a friction reducer provided herein may be in the range of from about 15% to about 90%, by weight, from about 25% to about 75%, by weight, from about 35% to about 60%, by weight, from about 40% to about 50%, by weight, or from about 40% to about 45%, by weight. In some embodiments, the overall concentration of the liquid medium in a friction reducer provided herein is about 15%, by weight, about 20%, by weight, about 25%, by weight, about 30%, by weight, about 35%, by weight, about 40%, by weight, about 43%, by weight, about 45%, by weight, about 50%, by weight, about 55%, by weight, about 60%, by weight, about 65%, by weight, about 70%, by weight, about 75%, by weight, about 80%, by weight, about 85%, by weight, or about 90%, by weight.

Stabilizing Agents

Solid components (e.g., thickening agents) suspended or dissolved in a liquid medium may settle over time. A stabilizing agent can be added to a friction reducer provided herein to facilitate keeping solid components suspended or dissolved in the liquid medium, either indefinitely, or for a length of time sufficient to maintain the friction reducer's utility for forming a fracturing fluid described herein.

In some embodiments, stabilizing agents suitable for use in friction reducers provided herein are capable of enhancing the storage and shelf life of the friction reducers, and/or preventing fouling of the friction reducers when they are exposed to freeze-thawing conditions, and/or improving the stability of the friction reducers at temperatures higher than 40° C.

Non-limiting examples of non-toxic, consumer-grade stabilizing agents include, but are not limited to, silica, glycogen particles, clays (e.g., bentonite), organophilically modified clays (e.g., organically modified montmorillonite), C18 or longer hydrocarbons, C12 or longer fatty acids and their derivatives, and any combination thereof. In the case of silica, the silica may be an amorphous silica, such as a fumed silica (for example, an Aerosilk), which can be a hydrophobic fumed silica. Examples of fatty acid derivatives include, but are not limited to, fatty alcohols, esters, amides, glycerides, phospholipids, and sphingolipids.

In some embodiments, the stabilizing agent is a solid at room temperature. The term “room temperature” is used herein to refer to a temperature in the range of from about 15° C. to about 30° C.

In some embodiments, the stabilizing agent is a particulate stabilizing agent. Particulate stabilizing agents can be synthetic or naturally occurring, and may be non-toxic, and/or consumer-grade. Particulate stabilizing agents may also be organophilic. Particulate stabilizing agents suitable for use in friction reducers provided herein are capable of binding to the surface of suspended droplets or particles of one substance in a suspension to prevent them from coalescing together (which would lead to breakup of the suspension).

In some embodiments, the friction reducer comprises clay as a particulate stabilizing agent. A clay may be included in any useful amount. In some embodiments, the clay may be smectite clay. Commercially available smectite clay is available under the trade designations Bentone^{™} SD1 and Bentone^{™} SD3.

In some embodiments, the friction reducer comprises silica as a particulate stabilizing agent. The silica may be present in the friction reducer at a concentration of from about 0.1% to about 2%, by weight (based on the total weight of the friction reducer), for example, from about 0.1% to about 1%, by weight, or from about 0.1% to about 0.5%, by weight, or from about 0.25% to about 0.75%, by weight, or about 0.5%, by weight.

In some embodiments, the friction reducer comprises glycogen particles as a particulate stabilizing agent. The glycogen particles may be glycogen nanoparticles, for example, phyto-glycogen nanoparticles. Such phyto-glycogen nanoparticles are commercially available, for example, from Mirexus Inc., and are entirely safe (edible), water-soluble and biodegradable. The phyto-glycogen nanoparticles may be present in the friction reducer at a concentration of from about 0.1% to about 15%, or from about 0.3% to about 10%, or from about 0.4% to about 5%, or from about 1% to about 5%, by weight (calculated based on the overall weight of the friction reducer).

As would be understood by a person of ordinary skill in the art, the amount of a stabilizing agent included in a friction reducer depends both on the nature of the liquid medium and the thickening agents in the friction reducer and on the final viscosity required for the application of the friction reducer.

Surfactants

In some embodiments, friction reducers provided herein comprise a first surfactant. Surfactants suitable for use in friction reducers provided herein are capable of forming long, flexible micelles that help resist the formation of turbulence in a fracturing fluid, and/or reducing the surface tension between the fracturing fluid, reservoir fluids and rocks, and/or improving flowback of the fracturing fluid after the fracturing process.

In some embodiments, the first surfactant may have an HLB value of at least 10. In some embodiments, the first surfactant is consumer-grade. In some embodiments, the first surfactant is a liquid at room temperature.

In some embodiments, the first surfactant is cashew nut shell liquid, derivatized cashew nut shell liquid, cardanol, ethoxylated phenolic lipid (such as ethoxylated cardanol), monoglyceride, fatty acid, fatty alcohol, glycolipid, polyglycerol ester, or a combination thereof.

In some embodiments, the weight percentage of the first surfactant in a friction reducer provided herein is 0.5-20 wt %, 0.5-15 wt %, 0.5-10 wt %, 2.5-20 wt %, 2.5-15 wt %, 2.5-10 wt %, 5-15 wt %, 5-10 wt %, or 10-20 wt %. In some embodiments, a friction reducer provided herein comprises about 0.5 wt %, about 2.5 wt %, about 5 wt %, or about 10 wt % of the first surfactant.

The present inventors have observed that friction reducers comprising a biopolymeric thickening agent and a first surfactant within weight percentage ranges provided herein have improved fluidity, and form fracturing fluids when combined with water or an aqueous solution that possess viscosity and elasticity that are more comparable to polyacrylamide-based friction reducers, compared to friction reducers not comprising a surfactant, or comprising a thickening agent and a surfactant outside weight percentage ranges provided herein.

In some embodiments, friction reducers provided herein further comprise a second surfactant. In some embodiments, the second surfactant has an HLB value less than 10. Without being limited by any particular theory, it is expected that the additional low-HLB surfactant may lower the surface tension of the liquid medium to facilitate dispersion of the thickening agent when mixing with water, and may also improve the adhesion characteristics of the fracturing fluid, thereby improving its penetration into fractures, as well as coating and dispersion of proppants.

In some embodiments, the second surfactant is cashew nut shell liquid, derivatized cashew nut shell liquid, cardanol, ethoxylated phenolic lipid (such as ethoxylated cardanol), monoglyceride, fatty acid, fatty alcohol, glycolipid, polyglycerol ester, or a combination thereof. In some embodiments, the second surfactant is a liquid at room temperature.

In some embodiments, the weight percentage of the second surfactant in a friction reducer provided herein is 0.5-20 wt %, 0.5-15 wt %, 0.5-10 wt %, 2.5-20 wt %, 2.5-15 wt %, 2.5-10 wt %, 5-15 wt %, 5-10 wt %, or 10-20 wt %. In some embodiments, the friction reducer comprises about 0.5 wt %, about 2.5 wt %, about 5 wt %, or about 10 wt % of the second surfactant.

In some embodiments, a friction reducer provided herein comprises 5 wt % of a first surfactant and about 5 wt % of a second surfactant. In some embodiments, a friction reducer provided herein comprises 10 wt % of a first surfactant and about 10 wt % of a second surfactant.

Elastomers

In some embodiments, friction reducers provided herein may comprise at least one elastomer. As used herein, an elastomer is a polymer that displays rubber-like elasticity. Without being limited by any particular theory, it is expected that an elastomer may reduce the flow resistance of the fracturing fluid in its turbulent state by storing the turbulence energy. The elastomer may be a thermoset or a thermoplastic.

In some embodiments, the elastomer may be a copolymer, such as a triblock copolymer or a graft copolymer. In some embodiments, the copolymer comprises at least one monomer derived from biomass, such as a terpene, lactone, plant oil, cellulose, plant resin (e.g., Dammar resin), lignin, or a combination thereof. In some embodiments, the copolymer comprises at least one olefin-based monomer, such as isoprene, styrene, butadiene, methacrylate, acrylate, or a combination thereof.

In some embodiments, the weight percentage of the elastomer in a friction reducer provided herein is 0.5-20 wt %, 0.5-15 wt %, 0.5-10 wt %, 2.5-20 wt %, 2.5-15 wt %, 2.5-10 wt %, 5-15 wt %, 5-10 wt %, or 10-20 wt %. In some embodiments, a friction reducer provided herein comprises about 0.5 wt %, about 2.5 wt %, about 5 wt %, or about 10 wt % of an elastomer.

Additives

Other components, or additives, can be added to friction reducers and/or fracturing fluids provided herein in order to affect or alter one or more properties of the friction reducers or the fracturing fluids formed from the friction reducers. The appropriate additive(s) can be incorporated as required for a particular use. For example, additives can be added to affect the stability of a friction reducer, and/or the resultant fracturing fluid. Additional additives that can be incorporated in a friction reducer and/or a fracturing fluid described herein include, but are not limited to, biocides, breakers, clay stabilizers, corrosion inhibitors, crosslinkers, demulsifiers, freeze point depressants, iron control agents, oxygen scavengers, pH control agents, preservatives, proppants, scale inhibitors, surfactants, or viscosifiers. As would be readily appreciated by one skilled in the art, a specific additive may fall within the definition of more than one of the aforementioned categories of additives.

Fracturing Fluids

Fracturing fluids for treating an oil and/or gas well having a wellbore can be formed by combining 0.01-10 wt % of a friction reducer provided herein with water or an aqueous solution to make up 100 wt %. In some embodiments, the weight percentage of the friction reducer in a fracturing fluid provided herein is 0.05-10 wt %, 0.1-10 wt %, 0.25-10 wt %, 0.5-10 wt %, 1-10 wt %, 3-10 wt %, 5-10 wt %, 0.01-5 wt %, 0.05-5 wt %, 0.1-5 wt %, 0.25-5 wt %, 0.5-5 wt %, 1-5 wt %, 3-5 wt %, 0.01-3 wt %, 0.05-3 wt %, 0.1-3 wt %, 0.25-3 wt %, 0.5-3 wt %, 1-3 wt %, 0.01-1 wt %, 0.05-1 wt %, 0.1-1 wt %, 0.25-1 wt %, 0.5-1 wt %, 0.01-0.5 wt %, 0.05-0.5 wt %, 0.1-0.5 wt %, 0.2-0.5 wt %, 0.25-0.5 wt %, 0.3-0.5 wt %, 0.4-0.5 wt %, 0.01-0.4 wt %, 0.05-0.4 wt %, 0.1-0.4 wt %, 0.2-0.4 wt %, 0.25-0.4 wt %, 0.3-0.4 wt %, 0.01-0.3 wt %, 0.05-0.3 wt %, 0.1-0.3 wt %, 0.2-0.3 wt %, 0.25-0.3 wt %, 0.01-0.25 wt %, 0.05-0.25 wt %, 0.1-0.25 wt %, 0.2-0.25 wt %, 0.01-0.2 wt %, 0.05-0.2 wt %, 0.1-0.2 wt %, 0.01-0.1 wt %, 0.05-0.1 wt %, or 0.01-0.05 wt %. In some embodiments, the weight percentage of the friction reducer in a fracturing fluid provided herein is about 0.01 wt %, about 0.05 wt %, about 0.1 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, or about 10 wt %.

In some embodiments, fracturing fluids provided herein may further comprise at least one additive, such as a biocide, breaker, clay stabilizer, corrosion inhibitor, crosslinker, demulsifier, freeze point depressant, iron control agent, oxygen scavenger, pH control agent, preservative, proppant, scale inhibitor, surfactant, viscosifier, or a combination thereof. In some embodiments, the at least one additive comprises 1-10 wt % of a surfactant. In some embodiments, the surfactant is an alcohol such as isopropanol. In some embodiments, the surfactant is consumer-grade. Examples of consumer-grade surfactants include, but are not limited to, cashew nut shell liquid, derivatized cashew nut shell liquid, cardanol, and ethoxylated phenolic lipid (such as ethoxylated cardanol).

Friction reducers of the present invention have been combined with water containing as much as 10 wt % salt to form fracturing fluids without change to their physical properties or performance. In some embodiments, the water is untreated. In some embodiments, the water is well water, pond water, river water, lake water, groundwater, produced water, or municipal water. In some embodiments, the aqueous solution is recycled flowback from the wellbore.

In some embodiments, fracturing fluids provided herein are slickwaters.

Polymers used in commercial slickwater friction reducers are typically based on polyacrylamide (PAM), a water-soluble polymer (typically with a molecular weight above 10⁵ Da) formed by the polymerization of acrylamide monomers in the presence of N,N′-methylenebis(acrylamide) as a crosslinking agent. Polyacrylamide with only acrylamide monomers is non-ionic. Polyacrylamide can be derivatized by copolymerization of acrylamide with other monomers such as acrylate or 2-acrylamido-2-methylpropane sulfonate (AMPS) at various percentages to form anionic PAM. Anionic PAM may exhibit better water solubility and may make the polymer more compatible with cationic minerals. The use of cationic PAM (derived from co-monomers such as dimethyldiallylammonium, N,N,N-trimethyl-2-((1-oxo-2-propenyl)oxy)ethanaminium, and 1,2-dimethyl-5-vinylpyridinium) in fracturing applications is also known to improve stability of the polymer under high-salinity conditions.

However, the use of polyacrylamide-based friction-reducing polymers has several drawbacks. Precise control of water hardness or salt concentration is often necessary to achieve proper dispersion and hydration of polyacrylamide-based polymers when they are mixed with water. This impedes the effective use of recycled flowback water with high ionic strength to form polyacrylamide-based slickwaters. Polyacrylamides are also susceptible to hydrolytic degradation at high temperatures and basic pH. When this occurs inside a wellbore containing water with high concentrations of multivalent cations such as Ca²⁺, Mg²⁺ and Fe⁺, hydrolyzed polyacrylamides may form complexes with these cations and precipitate out of water, causing damage to rock formations and reduced hydrocarbon production.

Furthermore, decomposition byproducts of polyacrylamides may include acrylamide monomer, a known environmental hazard that is highly mobile in aqueous environment and that is readily leachable from soil. The International Agency for Research on Cancer has categorized acrylamide as probably carcinogenic to humans (“Acrylamide in Drinking-water”, World Health Organization Report WHO/SDE/WSH/03.04/71, pp. 6-7 (2003)). Acrylamide may be removed from acrylamide-contaminated water via ozonation or treatment with potassium permanganate (WHO Report, supra), but these procedures are not economically feasible or readily adapted to subterranean treatment of large bodies of acrylamide-contaminated aqueous fluid.

The presence of acrylamide monomer in aqueous bodies of water or other aqueous fluids, whether subterranean or surface, is undesirable where such acrylamide-containing aqueous water bodies have the potential to contaminate groundwater, surface water or other drinking water sources. Treatment of such large bodies of water or other aqueous fluid is complicated by their large volumes, which are typically millions of liters or gallons.

By replacing polyacrylamide or derivatives thereof with biopolymeric thickening agents, slickwaters provided herein can be formed using various sources of water, such as well water, river water, pond water, lake water, groundwater, produced water, or municipal water, and are easier to clean up after fracturing (for example, by flushing with water without the use of a breaker).

In some embodiments, the weight percentage of the friction reducer in a slickwater provided herein is 0.01-3 wt %, 0.05-3 wt %, 0.1-3 wt %, 0.25-3 wt %, 0.5-3 wt %, 1-3 wt %, 0.01-1 wt %, 0.05-1 wt %, 0.1-1 wt %, 0.25-1 wt %, 0.5-1 wt %, 0.01-0.5 wt %, 0.05-0.5 wt %, 0.1-0.5 wt %, 0.2-0.5 wt %, 0.25-0.5 wt %, 0.3-0.5 wt %, 0.4-0.5 wt %, 0.01-0.4 wt %, 0.05-0.4 wt %, 0.1-0.4 wt %, 0.2-0.4 wt %, 0.25-0.4 wt %, 0.3-0.4 wt %, 0.01-0.3 wt %, 0.05-0.3 wt %, 0.1-0.3 wt %, 0.2-0.3 wt %, 0.25-0.3 wt %, 0.01-0.25 wt %, 0.05-0.25 wt %, 0.1-0.25 wt %, 0.2-0.25 wt %, 0.01-0.2 wt %, 0.05-0.2 wt %, 0.1-0.2 wt %, 0.01-0.1 wt %, 0.05-0.1 wt %, or 0.01-0.05 wt %. In some embodiments, the weight percentage of the friction reducer in a slickwater provided herein is about 0.01 wt %, 0.05 wt %, 0.1 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, or about 3 wt %.

In some embodiments, a slickwater provided herein has a viscosity of 2-10 cP, measured at 100 s⁻¹ and 20° C. In some embodiments, a slickwater provided herein has about 50%, about 55%, about 60%, about 65%, about 70%, about 75%, about 80%, or about 85% reduced friction compared to water without a friction reducer.

Methods

Methods of treating an oil and/or gas well having a wellbore provided herein comprise combining a friction reducer provided herein with water or an aqueous solution to form a fracturing fluid, and delivering the fracturing fluid into the wellbore.

In the methods provided herein, the combining step may take place on a fracturing site. The combining step may involve the use of a blender. In some embodiments, the blender is a low pressure unit with three important components: a suction pump, mixing tub and discharge pump.

The suction and discharge pumps may be of the centrifugal type. Blenders take water from the fluid tanks with a suction pump, which sends the water to a mixing tub. The mixing tub mixes the water with proppant that is delivered by sand screws. Additional chemicals can also be delivered to the mixing tub. Dry chemicals are delivered by a dry additive system mounted on the blender. Liquid additives are delivered by a liquid additive system either mounted on-board or off-board the blender. A discharge pump pulls the mixture from the mixing tub and discharges it to the discharge manifold on the blender. From the discharge manifold, the mixture is sent to the manifold trailer and is transferred to the high-pressure pumps, which discharge the mixture under pressure to the wellhead.

In some embodiments, blenders are computer controlled, enabling the flow of chemicals and ingredients to be efficiently metered and to achieve good control over the blend quality and delivery rate. Nevertheless, when typical polyacrylamide-based slickwaters are mixed, the mixing process must be carefully monitored to ensure proper dispersal and hydration of the polymer and to prevent clumping. Friction reducers provided herein may be less sensitive to the pH and salt content of the water or aqueous solution they are being combined with to create slickwaters. Accordingly, in some embodiments, the combining step takes place without pH, salinity, metal, and/or water hardness control.

In some embodiments, the combining step uses a metered liquid injection system. An example of a metered liquid injection system comprises a power supply, a paddle wheel flow meter, and a vector drive motor controlled via an interconnect cable by a programmable logic controller (PLC). The PLC can be manipulated to adjust the percentage of a friction reducer to be added to the water or aqueous solution stream.

Storage of fracturing fluids can occupy large amounts of space at fracturing sites. For hydraulic fracturing treatments in conventional reservoirs, fluids are brought to location by trucks and stored in fluid tanks at the fracturing site. For unconventional developments, multiple horizontal wells are drilled and stimulated by hydraulic fracturing on a single well pad. Due to the tremendous amount of water required to stimulate these horizontal wells, a temporary water pond is commonly constructed to store water from various sources including well water, river water, pond water, lake water, groundwater, produced water, or municipal water. A single water pond is often built to provide water for fracturing treatments on multiple well pads.

In some embodiments, the delivery of fracturing fluid into the wellbore requires the use of specialized high-pressure pumps along with monitor and control equipment (e.g. data vans) and ancillary equipment such as hoses, pipes, valves, and manifolds, etc.

Pumps used to pressurize the fracturing fluid system in hydraulic fracturing applications are designed to withstand high-pressure conditions. For that reason, these pumps are often called high-pressure pumps or frac pumps to distinguish them from other types of pumps used in oilfield applications. In some embodiments, the fracturing fluids provided herein are delivered into the wellbore at 3,000-20,000 psi. High-pressure pumps generally come in two types, triplex and quintuplex, and are able to provide hydraulic horsepower up to 3000 hhp. Several pumps may be used for a typical treatment, and the number of pumps required is determined by the anticipated pumping rates and pressures. The low-pressure suction end of a frac pump pulls the fluid from the blender. The high-pressure discharge end of a frac pump sends the fluid to the wellhead via a high-pressure treating line. Isolation and bleed-off valves are installed and tied into the high-pressure treating line to facilitate taking the pump offline and making minor repairs during pumping operations. High-pressure pumps for onshore hydraulic fracturing applications are typically mounted on trucks.

The manifold, often called “missile,” is an arrangement of flow lines, fittings and valves that connect all fracturing equipment to the wellhead. It has both a low-pressure side tied to the blender and a high-pressure side tied to the wellhead, with all the high-pressure pumps in between to pressurize the fluid system. A modular and flexible manifold trailer is often used to help organize both the low-pressure suction hookup and the high-pressure discharge hookup. The number of suction hoses between the blender and the high-pressure pumps is determined by the pump rate. As a part of the manifold system, the high-pressure flow line that transmits the fluid discharged from the high-pressure pumps to the wellhead is often called “treating iron” as it is made of metal pipe. The size of the high-pressure pipe is determined by both the anticipated pumping rates and pressures. Lines with smaller sizes have higher pressure ratings than those with larger ones. The treating iron and associated connections are machined from single pieces of metal without welded seams to withstand the harsh conditions caused by high pressures, abrasive fluids, vibration, and wear and tear.

The pumping pressure and flow rate chosen in a hydraulic fracturing treatment are generally dependent on the formation, and the equipment used is generally chosen to meet the requirements of the formation. For example, wellbores in the Duvernay formation found in parts of Alberta and BC may be treated at 10,000-12,000 psi and flow rates of 12-15 m³ per minute, while wellbores in the Montney formation may be treated at 8,000-10,000 psi and flow rates of 12-15 m³ per minute. Other variables that are taken into account when choosing a proper pumping pressure and flow rate include the size of the well casing (e.g., 4.5 inches vs. 5.5 inches), the depth of the treatment, the type of water used (e.g., flowback water), and the type of fracturing fluids and proppant used. In some embodiments, fracturing fluids provided herein are delivered into the wellbore at 5-20 m³/min, 9-18 m³/min, or 12-15 m³/min. In some embodiments, fracturing fluids provided herein are delivered into the wellbore at 5,000-12,000 psi, 8,000-12,000 psi, 8,000-10,000 psi, or 10,000-12,000 psi.

### Embodiments

Particular embodiments of the invention include, without limitation, the following:

1. A method of treating an oil and/or gas well having a wellbore, comprising: combining a friction reducer with water or an aqueous solution to form a fracturing fluid, and delivering the fracturing fluid into the wellbore, wherein the friction reducer comprises:

a. 10-75 wt % of a thickening agent;

b. 15-90 wt % of a liquid medium; and

c. a stabilizing agent,

wherein the friction reducer does not comprise polyacrylamide or a derivative thereof.

2. The method of paragraph 1, wherein the friction reducer consists of >75%, >80%, >85%, >90%, >95%, >98% or 100% by weight consumer-grade components.

3. The method of paragraphs 1 or 2, wherein the thickening agent is a biopolymeric thickening agent.

4. The method of any one of paragraphs 1 to 3, wherein the friction reducer does not comprise a viscosifier that is not the thickening agent.

5. The method of any one of paragraphs 1 to 4, wherein the thickening agent comprises more than one polysaccharide.

6. The method of paragraph 5, wherein the thickening agent comprises two, three, or four polysaccharides.

7. The method of any one of paragraphs 1 to 6, wherein the friction reducer comprises 20-50 wt % of the thickening agent.

8. The method of any one of paragraphs 1 to 7, wherein the thickening agent comprises a gum, a starch, or a combination of a gum and a starch.

9. The method of paragraph 8, wherein the gum is guar gum, xanthan gum, locust bean gum, or a combination thereof.

10. The method of paragraph 9, wherein the gum is guar gum, xanthan gum, or a combination thereof.

11. The method of any one of paragraphs 8 to 10, wherein the starch is cornstarch, potato starch, tapioca, rice starch, carboxymethylcellulose sodium salt, or a combination thereof.

12. The method of paragraph 11, wherein the starch is cornstarch.

13. The method of any one of paragraphs 1 to 12, wherein the friction reducer comprises 23-62 wt % of the liquid medium.

14. The method of any one of paragraphs 1 to 13, wherein the liquid medium is an edible oil, castor bean oil, pine tree sap, petroleum distillate, mineral oil, glycerol, low-molecular weight polyethylene glycol (PEG), or a combination thereof.

15. The method of paragraph 14, wherein the edible oil is a nut oil, seed oil, plant oil, vegetable oil, or a combination thereof.

16. The method of paragraph 15, wherein the vegetable oil is canola oil.

17. The method of paragraph 15, wherein the seed oil is linseed oil.

18. The method of any one of paragraphs 1 to 16, wherein the friction reducer comprises guar gum, xanthan gum, cornstarch, and canola oil.

19. The method of any one of paragraphs 1 to 18, wherein the friction reducer further comprises 0.5-20 wt % of a first surfactant.

20. The method of paragraph 19, wherein the first surfactant has an HLB value of at least 10.

21. The method of paragraphs 19 or 20, wherein the first surfactant is consumer-grade.

22. The method of any one of paragraphs 19 to 21, wherein the first surfactant is cashew nut shell liquid, derivatized cashew nut shell liquid, cardanol, ethoxylated phenolic lipid, monoglyceride, fatty acid, fatty alcohol, glycolipid, polyglycerol ester, or a combination thereof.

23. The method of any one of paragraphs 19 to 22, wherein the first surfactant is cardanol.

24. The friction reducer of paragraph 22, wherein the ethoxylated phenolic lipid is ethoxylated cardanol.

25. The method of any one of paragraphs 19 to 24, wherein the first surfactant is a liquid at room temperature.

26. The method of any one of paragraphs 19 to 25, wherein the friction reducer further comprises 0.5-20 wt % of a second surfactant.

27. The method of paragraph 26, wherein the second surfactant has an HLB value of less than 10.

28. The method of paragraphs 26 or 27, wherein the second surfactant is cashew nut shell liquid, derivatized cashew nut shell liquid, cardanol, ethoxylated phenolic lipid, monoglyceride, fatty acid, fatty alcohol, glycolipid, polyglycerol ester, or a combination thereof.

29. The method of paragraph 28, wherein the second surfactant is cardanol.

30. The method of paragraph 28, wherein the ethoxylated phenolic lipid is ethoxylated cardanol.

31. The method of any one of paragraphs 26 to 30, wherein the second surfactant is a liquid at room temperature.

32. The method of any one of paragraphs 26 to 31 wherein the friction reducer comprises about 5 wt % of the first surfactant and about 5 wt % of the second surfactant.

33. The method of any one of paragraphs 26 to 32, wherein the friction reducer comprises about 10 wt % of the first surfactant and about 10 wt % of the second surfactant.

34. The method of any one of paragraphs 1 to 33, wherein the friction reducer further comprises 0.5-20 wt % of an elastomer.

35. The method of paragraph 34, wherein the elastomer is a copolymer.

36. The method of paragraph 35, wherein the elastomer is a triblock copolymer or a graft copolymer.

37. The method of paragraphs 35 or 36, wherein the copolymer comprises at least one monomer derived from biomass.

38. The method of paragraph 37, wherein the at least one monomer derived from biomass is a terpene, lactone, plant oil, cellulose, plant resin, lignin, or a combination thereof.

39. The method of paragraph 38, wherein the plant resin is Dammar resin.

40. The method of any one of paragraphs 34 to 39, wherein the copolymer comprises at least one olefin-based monomer.

41. The method of paragraph 40, wherein the at least one olefin-based monomer is isoprene, styrene, butadiene, methacrylate, acrylate, or a combination thereof.

42. The method of any one of paragraphs 1 to 41, wherein the stabilizing agent is a solid at room temperature.

43. The method of any one of paragraphs 1 to 42, wherein the stabilizing agent is particulate.

44. The method of any one of paragraphs 1 to 43, wherein the stabilizing agent is selected from the group consisting of silica, glycogen, bentonite, C18 or longer hydrocarbons, C12 or longer fatty acids and their derivatives, and any combination thereof.

45. The method of any one of paragraphs 1 to 44, wherein the friction reducer further comprises at least one additive.

46. The method of paragraph 45, wherein the at least one additive is a biocide, breaker, clay stabilizer, corrosion inhibitor, crosslinker, demulsifier, freeze point depressant, iron control agent, oxygen scavenger, pH control agent, preservative, proppant, scale inhibitor, viscosifier, or a combination thereof.

47. The method of any one of paragraphs 1 to 46, wherein the combining step takes place on a fracturing site.

48. The method of any one of paragraphs 1 to 47, wherein the water is untreated.

49. The method of any one of paragraphs 1 to 48, wherein the water is well water, pond water, river water, lake water, groundwater, produced water, or municipal water.

50. The method of any one of paragraphs 1 to 49, wherein the water is salt water or brackish water.

51. The method of any one of paragraphs 1 to 47, wherein the aqueous solution is recycled flowback from the wellbore.

52. The method of any one of paragraphs 1 to 51, wherein the combining step takes place without pH, salinity, metal, and/or water hardness control.

53. The method of any one of paragraphs 1 to 52, wherein the combining step uses a metered liquid injection system.

54. The method of any one of paragraphs 1 to 53, wherein the combining step further comprises adding at least one additive to the fracturing fluid.

55. The method of any one of paragraphs 1 to 54, wherein the at least one additive is a biocide, breaker, clay stabilizer, corrosion inhibitor, crosslinker, demulsifier, freeze point depressant, iron control agent, oxygen scavenger, pH control agent, preservative, proppant, scale inhibitor, viscosifier, or a combination thereof.

56. The method of paragraph any one of paragraphs 1 to 55, wherein the fracturing fluid is a slickwater.

57. The method of paragraph 56, wherein the slickwater has a viscosity of 2-10 cP, measured at 100 s⁻¹ and 20° C.

58. The method of paragraph 56 or 57, wherein the slickwater has about 50%, about 55%, about 60%, about 65%, about 70%, about 75%, about 80%, or about 85% reduced friction compared to water without a friction reducer.

59. A friction reducer comprising:

a. 10-75 wt % of a thickening agent;

b. 15-90 wt % of a liquid medium;

c. 0.5-20 wt % of a first surfactant; and

d. a stabilizing agent.

60. The friction reducer of paragraph 59, wherein the friction reducer does not comprise polyacrylamide or a derivative thereof.

61. The friction reducer of paragraph 59 or 60, wherein the thickening agent is a biopolymeric thickening agent.

62. The friction reducer of any one of paragraphs 59 to 61, wherein the friction reducer does not comprise a viscosifier that is not the thickening agent.

63. The friction reducer of any one of paragraphs 59 to 62, wherein the friction reducer consists of >75%, >80%, >85%, >90%, >95%, >98% or 100% by weight consumer-grade components.

64. The friction reducer of any one of paragraphs 59 to 63, wherein the thickening agent comprises more than one polysaccharide.

65. The friction reducer of paragraph 64, wherein the thickening agent comprises two, three, or four polysaccharides.

66. The friction reducer of any one of paragraphs 59 to 65, wherein the friction reducer comprises 20-50 wt % of the thickening agent.

67. The friction reducer of any one of paragraphs 59 to 66, wherein the thickening agent comprises a gum, a starch, or a combination of a gum and a starch.

68. The friction reducer of paragraph 67, wherein the gum is guar gum, xanthan gum, locust bean gum, or a combination thereof.

69. The friction reducer of paragraph 68, wherein the gum is guar gum, xanthan gum, or a combination thereof.

70. The friction reducer of any one of paragraphs 67 to 69, wherein the starch is cornstarch, potato starch, tapioca, rice starch, carboxymethylcellulose sodium salt, or a combination thereof.

71. The friction reducer of paragraph 70, wherein the starch is cornstarch.

72. The friction reducer of any one of paragraphs 59 to 71, wherein the friction reducer comprises 23-62 wt % of the liquid medium.

73. The friction reducer of any one of paragraphs 59 to 72, wherein the liquid medium is an edible oil, castor bean oil, pine tree sap, petroleum distillate, mineral oil, glycerol, low-molecular weight polyethylene glycol (PEG), or a combination thereof.

74. The friction reducer of paragraph 73, wherein the edible oil is a nut oil, seed oil, plant oil, vegetable oil, or a combination thereof.

75. The friction reducer of paragraph 74, wherein the vegetable oil is canola oil.

76. The friction reducer of paragraph 74, wherein the seed oil is linseed oil.

77. The friction reducer of any one of paragraphs 59 to 75, wherein the friction reducer comprises guar gum, xanthan gum, cornstarch, and canola oil.

78. The friction reducer of any one of paragraphs 59 to 77, wherein the first surfactant has an HLB value of at least 10.

79. The friction reducer of any one of paragraphs 59 to 78, wherein the first surfactant is consumer-grade.

80. The friction reducer of any one of paragraphs 59 to 79, wherein the first surfactant is cashew nut shell liquid, derivatized cashew nut shell liquid, cardanol, ethoxylated phenolic lipid, monoglyceride, fatty acid, fatty alcohol, glycolipid, polyglycerol ester, or a combination thereof.

81. The friction reducer of paragraph 80, wherein the first surfactant is cardanol.

82. The friction reducer of paragraph 80, wherein the ethoxylated phenolic lipid is ethoxylated cardanol.

83. The friction reducer of any one of paragraphs 59 to 82, wherein the first surfactant is a liquid at room temperature.

84. The friction reducer of any one of paragraphs 59 to 83, wherein the friction reducer further comprises 0.5-20 wt % of a second surfactant.

85. The friction reducer of paragraph 84, wherein the second surfactant has an HLB value of less than 10.

86. The friction reducer of paragraphs 84 or 85, wherein the second surfactant is cashew nut shell liquid, derivatized cashew nut shell liquid, cardanol, ethoxylated phenolic lipid, monoglyceride, fatty acid, fatty alcohol, glycolipid, polyglycerol ester, or a combination thereof.

87. The friction reducer of paragraph 86, wherein the ethoxylated phenolic lipid is ethoxylated cardanol.

88. The friction reducer of any one of paragraphs 84 to 87, wherein the second surfactant is a liquid at room temperature.

89. The friction reducer of any one of paragraphs 84 to 88, wherein the friction reducer comprises about 5 wt % of the first surfactant and about 5 wt % of the second surfactant.

90. The friction reducer of any one of paragraphs 84 to 89, wherein the friction reducer comprises about 10 wt % of the first surfactant and about 10 wt % of the second surfactant.

91. The friction reducer of any one of paragraphs 59 to 90, wherein the stabilizing agent is a solid at room temperature.

92. The friction reducer of any one of paragraphs 59 to 91, wherein the stabilizing agent is particulate.

93. The friction reducer of any one of paragraphs 59 to 92, wherein the stabilizing agent is selected from the group consisting of silica, glycogen, bentonite, C18 or longer hydrocarbons, C12 or longer fatty acids and their derivatives, and any combination thereof.

94. The friction reducer of any one of paragraphs 59 to 93, wherein the friction reducer further comprises at least one additive.

95. The friction reducer of paragraph 94, wherein the at least one additive is a biocide, breaker, clay stabilizer, corrosion inhibitor, crosslinker, demulsifier, freeze point depressant, iron control agent, oxygen scavenger, pH control agent, preservative, proppant, scale inhibitor, viscosifier, or a combination thereof.

96. A friction reducer comprising:

a. 10-75 wt % of a thickening agent;

b. 15-90 wt % of a liquid medium;

c. 0.5-20 wt % of an elastomer; and

d. a stabilizing agent.

97. The friction reducer of paragraph 96, wherein the friction reducer does not comprise polyacrylamide or a derivative thereof.

98. The friction reducer of paragraph 96 or 97, wherein the thickening agent is a biopolymeric thickening agent.

99. The friction reducer of any one of paragraphs 96 to 98, wherein the friction reducer does not comprise a viscosifier that is not the thickening agent.

100. The friction reducer of any one of paragraphs 96 to 99, wherein the friction reducer

consists of >75%, >80%, >85%, >90%, >95%, >98% or 100% by weight consumer-grade components.

101. The friction reducer of any one of paragraphs 96 to 100, wherein the thickening agent comprises more than one polysaccharide.

102. The friction reducer of paragraph 101, wherein the thickening agent comprises two, three, or four polysaccharides.

103. The friction reducer of any one of paragraphs 96 to 102, wherein the friction reducer comprises 20-50 wt % of the thickening agent.

104. The friction reducer of any one of paragraphs 96 to 103, wherein the thickening agent comprises a gum, a starch, or a combination of a gum and a starch.

105. The friction reducer of paragraph 104, wherein the gum is guar gum, xanthan gum, locust bean gum, or a combination thereof.

106. The friction reducer of paragraph 105, wherein the gum is guar gum, xanthan gum, or a combination thereof.

107. The friction reducer of any one of paragraphs 104 to 106, wherein the starch is cornstarch, potato starch, tapioca, rice starch, carboxymethylcellulose sodium salt, or a combination thereof.

108. The friction reducer of paragraph 107, wherein the starch is cornstarch.

109. The friction reducer of any one of paragraphs 96 to 108, wherein the friction reducer comprises 23-62 wt % of the liquid medium.

110. The friction reducer of any one of paragraphs 96 to 109, wherein the liquid medium is an edible oil, castor bean oil, pine tree sap, petroleum distillate, mineral oil, glycerol, low-molecular weight polyethylene glycol (PEG), or a combination thereof.

111. The friction reducer of paragraph 110, wherein the edible oil is a nut oil, seed oil, plant oil, vegetable oil, or a combination thereof.

112. The friction reducer of paragraph 111, wherein the vegetable oil is canola oil.

113. The friction reducer of paragraph 111, wherein the seed oil is linseed oil.

114. The friction reducer of any one of paragraphs 96 to 112, wherein the friction reducer comprises guar gum, xanthan gum, cornstarch, and canola oil.

115. The friction reducer of any one of paragraphs 96 to 114, wherein the elastomer is a copolymer.

116. The friction reducer of paragraph 115, wherein the elastomer is a triblock copolymer or a graft copolymer.

117. The friction reducer of paragraphs 115 or 116, wherein the copolymer comprises at least one monomer derived from biomass.

118. The friction reducer of paragraph 117, wherein the at least one monomer derived from biomass is a terpene, lactone, plant oil, cellulose, plant resin, lignin, or a combination thereof.

119. The friction reducer of paragraph 118, wherein the plant resin is Dammar resin.

120. The friction reducer of any one of paragraphs 115 to 119, wherein the copolymer comprises at least one olefin-based monomer.

121. The friction reducer of paragraph 120, wherein the at least one olefin-based monomer is isoprene, styrene, butadiene, methacrylate, acrylate, or a combination thereof.

122. The friction reducer of any one of paragraphs 96 to 121, wherein the stabilizing agent is a solid at room temperature.

123. The friction reducer of any one of paragraphs 96 to 122, wherein the stabilizing agent is particulate.

124. The friction reducer of any one of paragraphs 96 to 123, wherein the stabilizing agent is selected from the group consisting of silica, glycogen, bentonite, C18 or longer hydrocarbons, C12 or longer fatty acids and their derivatives, and any combination thereof.

125. The friction reducer of any one of paragraphs 96 to 124, wherein the friction reducer further comprises 0.5-20 wt % of a first surfactant.

126. The friction reducer of paragraph 125, wherein the first surfactant has an HLB value of at least 10.

127. The friction reducer of paragraphs 125 or 126, wherein the first surfactant is consumer-grade.

128. The friction reducer of any one of paragraphs 125 to 127, wherein the first surfactant is cashew nut shell liquid, derivatized cashew nut shell liquid, cardanol, ethoxylated phenolic lipid, monoglyceride, fatty acid, fatty alcohol, glycolipid, polyglycerol ester, or a combination thereof.

129. The friction reducer of paragraph 128, wherein the first surfactant is cardanol.

130. The friction reducer of paragraph 128, wherein the ethoxylated phenolic lipid is ethoxylated cardanol.

131. The friction reducer of any one of paragraphs 125 to 130, wherein the first surfactant is a liquid at room temperature.

132. The friction reducer of any one of paragraphs 125 to 131, wherein the friction reducer further comprises 0.5-20 wt % of a second surfactant.

133. The friction reducer of paragraph 132, wherein the second surfactant has an HLB value of less than 10.

134. The friction reducer of paragraphs 132 or 133, wherein the second surfactant is cashew nut shell liquid, derivatized cashew nut shell liquid, cardanol, ethoxylated phenolic lipid, monoglyceride, fatty acid, fatty alcohol, glycolipid, polyglycerol ester, or a combination thereof.

135. The friction reducer of paragraph 134, wherein the ethoxylated phenolic lipid is ethoxylated cardanol.

136. The friction reducer of any one of paragraphs 132 to 135, wherein the second surfactant is a liquid at room temperature.

137. The friction reducer of any one of paragraphs 132 to 136, wherein the friction reducer comprises about 5 wt % of the first surfactant and about 5 wt % of the second surfactant.

138. The friction reducer of any one of paragraphs 132 to 136, wherein the friction reducer comprises about 10 wt % of the first surfactant and about 10 wt % of the second surfactant.

139. A fracturing fluid comprising:

a. 0.01-10 wt % of the friction reducer of any one of paragraphs 59 to 138; and

b. water or an aqueous solution to make up 100 wt %.

140. The fracturing fluid of paragraph 139, wherein the weight percentage of the friction reducer is 0.05-10 wt %, 0.1-10 wt %, 0.25-10 wt %, 0.5-10 wt %, 1-10 wt %, 3-10 wt %, 5-10 wt %, 0.01-5 wt %, 0.05-5 wt %, 0.1-5 wt %, 0.25-5 wt %, 0.5-5 wt %, 1-5 wt %, 3-5 wt %, 0.01-3 wt %, 0.05-3 wt %, 0.1-3 wt %, 0.25-3 wt %, 0.5-3 wt %, 1-3 wt %, 0.01-1 wt %, 0.05-1 wt %, 0.1-1 wt %, 0.25-1 wt %, 0.5-1 wt %, 0.01-0.5 wt %, 0.05-0.5 wt %, 0.1-0.5 wt %, 0.2-0.5 wt %, 0.25-0.5 wt %, 0.3-0.5 wt %, 0.4-0.5 wt %, 0.01-0.4 wt %, 0.05-0.4 wt %, 0.1-0.4 wt %, 0.2-0.4 wt %, 0.25-0.4 wt %, 0.3-0.4 wt %, 0.01-0.3 wt %, 0.05-0.3 wt %, 0.1-0.3 wt %, 0.2-0.3 wt %, 0.25-0.3 wt %, 0.01-0.25 wt %, 0.05-0.25 wt %, 0.1-0.25 wt %, 0.2-0.25 wt %, 0.01-0.2 wt %, 0.05-0.2 wt %, 0.1-0.2 wt %, 0.01-0.1 wt %, 0.05-0.1 wt %, or 0.01-0.05 wt %.

141. The fracturing fluid of paragraph 140, wherein the weight percentage of the friction reducer is about 0.01 wt %, about 0.05 wt %, about 0.1 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, or about 10 wt %.

142. The fracturing fluid of any one of paragraphs 139 to 141, wherein the fracturing fluid further comprises at least one additive.

143. The fracturing fluid of paragraph 142, wherein the at least one additive is a biocide, breaker, clay stabilizer, corrosion inhibitor, crosslinker, demulsifier, freeze point depressant, iron control agent, oxygen scavenger, pH control agent, preservative, proppant, scale inhibitor, surfactant, viscosifier, or a combination thereof.

144. The fracturing fluid of paragraph 143, wherein the at least one additive comprises 1-10 wt % of a surfactant.

145. The fracturing fluid of paragraph 144, wherein the surfactant is an alcohol.

146. The fracturing fluid of paragraph 145, wherein the alcohol is isopropanol.

147. The fracturing fluid of any one of paragraphs 143 to 145, wherein the surfactant is consumer-grade.

148. The fracturing fluid of paragraph 147, wherein the consumer-grade surfactant is a cashew nut shell liquid, derivatized cashew nut shell liquid, cardanol, or ethoxylated phenolic lipid.

149. The friction reducer of paragraph 148, wherein the consumer-grade surfactant is cardanol.

150. The friction reducer of paragraph 148, wherein the ethoxylated phenolic lipid is ethoxylated cardanol.

151. The fracturing fluid of any one of paragraphs 139 to 150, wherein the water is untreated.

152. The fracturing fluid of any one of paragraphs 139 to 151, wherein the water is well water, pond water, river water, lake water, groundwater, produced water, or municipal water.

153. The fracturing fluid of any one of paragraphs 139 to 152, wherein the aqueous solution is recycled flowback from the wellbore.

154. The fracturing fluid of any one of paragraphs 130 to 153, wherein the water is salt water or brackish water.

155. The fracturing fluid of any one of paragraphs 139 to 154, wherein the fracturing fluid is a slickwater.

156. The fracturing fluid of paragraph 155, which has a viscosity of 2-10 cP, measured at 100 s⁻¹ and 20° C.

157. The fracturing fluid of paragraph 155 or 156, which has about 50%, about 55%, about 60%, about 65%, about 70%, about 75%, about 80%, or about 85% reduced friction compared to water without a friction reducer.

158. The method of any one of paragraphs 1 to 58, wherein the fracturing fluid is delivered into the wellbore at 5-20 m³/min, 9-18 m³/min, or 12-15 m³/min.

159. The method of any one of paragraphs 1 to 58 or 158, wherein the fracturing fluid is delivered into the wellbore at 3,000-20,000 psi, 5,000-12,000 psi, 8,000-12,000 psi, 8,000-10,000 psi, or 10,000-12,000 psi.

### Examples

### Example 1: A Formula for a Friction Reducer Comprising One Surfactant

In one example, a friction reducer of the present invention is formulated from the following components:

15-25 wt % xanthan gum, e.g., 20 wt %

10-20 wt % guar gum, e.g., 14.4 wt %

10-20 wt % cornstarch, e.g., 14.4 wt %

0.5-20 wt % cashew nut shell liquid ethoxylate, e.g., 10 wt %

1-5 wt % stabilizing agent

30-63.5 wt % canola oil, e.g., 36.2-40.2 wt %.

When mixed with water, friction reducers of the above formulation formed white milky fracturing fluids that provided enhanced surface lubrication. At concentrations of 2-10 wt % in water, the fracturing fluids had a gel-like consistency, i.e., they were viscous, thicker, and stickier (more adhesive to surfaces). At more dilute concentrations (e.g., below 1 wt % in water), the fracturing fluids were thinner and more pourable.

### Example 2: A Formula for a Friction Reducer Comprising Two Surfactants

In another example, a friction reducer of the present invention is formulated from the following components:

15-25 wt % xanthan gum, e.g., 20 wt %

10-20 wt % guar gum, e.g., 14.4 wt %

10-20 wt % cornstarch, e.g., 14.4 wt %

0.5-20 wt % cashew nut shell liquid ethoxylate with HLB>10, e.g., 5 wt %

0.5-20 wt % cashew nut shell liquid ethoxylate with HLB<10, e.g., 5 wt %

1-5 wt % stabilizing agent

30-63 wt % canola oil, e.g., 36.2-40.2 wt %.

### Example 3: A Formula for a Friction Reducer Comprising an Elastomer

In another example, a friction reducer of the present invention is formulated from the following components:

15-25 wt % xanthan gum, e.g., 20 wt %

10-20 wt % guar gum, e.g., 14.4 wt %

10-20 wt % cornstarch, e.g., 14.4 wt %

0.5-20 wt % elastomer, e.g., 10 wt %

1-5 wt % stabilizing agent

30-63 wt % canola oil, e.g., 36.2-40.2 wt %.

Although the foregoing invention has been described in some detail by way of illustration and example for purposes of clarity of understanding, it is readily apparent to those of ordinary skill in the art in light of the teachings of this invention that certain changes and modifications may be made thereto without departing from the scope of the appended claims.

It must be noted that as used in this specification and the appended claims, the singular forms “a,” “an,” and “the” include plural reference unless the context clearly dictates otherwise. Unless defined otherwise all technical and scientific terms used herein have the same meaning as commonly understood to one of ordinary skill in the art to which this invention belongs.

The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined.

Other elements may optionally be present other than the elements specifically identified by the “and/or” clause, whether related or unrelated to those elements specifically identified.

Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to encompass the same meaning as “and/or” as defined above.

For example, when separating items in a list, “or” or “and/or” shall be interpreted as being inclusive, i.e., the inclusion of at least one, but also including more than one, of a number or list of elements, and, optionally, additional unlisted items.

As used herein, whether in the specification or the appended claims, the transitional terms “comprising”, “including”, “having”, “containing”, “involving”, and the like are to be understood as being inclusive or open-ended (i.e., to mean including but not limited to), and they do not exclude unrecited elements, materials or method steps. Only the transitional phrases “consisting of” and “consisting essentially of”, respectively, are closed or semi-closed transitional phrases with respect to claims and exemplary embodiment paragraphs herein. The transitional phrase “consisting of” excludes any element, step, or ingredient which is not specifically recited.

The transitional phrase “consisting essentially of” limits the scope to the specified elements, materials or steps and to those that do not materially affect the basic characteristic(s) of the invention disclosed and/or claimed herein.

1. A method of treating an oil and/or gas well having a wellbore, comprising:
combining a friction reducer with water or an aqueous solution to form a fracturing fluid, and
delivering the fracturing fluid into the wellbore,
wherein the friction reducer comprises:
a. 10-75 wt % of a thickening agent;
b. 15-90 wt % of a liquid medium; and
c. a stabilizing agent,
wherein the friction reducer does not comprise polyacrylamide or a derivative thereof.

2. The method of claim 1, wherein the friction reducer consists of >75%, >80%, >85%, >90%, >95%, >98% or 100% by weight consumer-grade components.

3. The method of claim 1, wherein the thickening agent is a biopolymeric thickening agent.

4. The method of claim 1, wherein the thickening agent comprises a gum, a starch, or a combination of a gum and a starch.

5. The method of claim 1, wherein the combining step takes place on a fracturing site.

6. The method of claim 1, wherein the water is untreated.

7. The method of claim claim 1, wherein the fracturing fluid is a slickwater.

8. A friction reducer comprising:
a. 10-75 wt % of a thickening agent;
b. 15-90 wt % of a liquid medium;
c. 0.5-20 wt % of a first surfactant; and
d. a stabilizing agent.

9. The friction reducer of claim 8, wherein the friction reducer does not comprise polyacrylamide or a derivative thereof.

10. The friction reducer of claim 8, wherein the thickening agent is a biopolymeric thickening agent.

11. The friction reducer of claim 8, wherein the friction reducer does not comprise a viscosifier that is not the thickening agent.

12. The friction reducer of claim 8, wherein the friction reducer consists of >75%, >80%, >85%, >90%, >95%, >98% or 100% by weight consumer-grade components.

13. The friction reducer of claim 8, wherein the thickening agent comprises a gum, a starch, or a combination of a gum and a starch.

14. The friction reducer of claim 8, wherein the first surfactant has an HLB value of at least 10.

15. The friction reducer of claim 8, wherein the friction reducer further comprises 0.5-20 wt % of a second surfactant, wherein the second surfactant optionally has an HLB value of less than 10.

16. The friction reducer of claim 8, wherein the stabilizing agent is selected from the group consisting of silica, glycogen, bentonite, C18 or longer hydrocarbons, C12 or longer fatty acids and their derivatives, and any combination thereof.

17. A friction reducer comprising:
a. 10-75 wt % of a thickening agent;
b. 15-90 wt % of a liquid medium;
c. 0.5-20 wt % of an elastomer; and
d. a stabilizing agent.

18. The friction reducer of claim 17, wherein the friction reducer does not comprise polyacrylamide or a derivative thereof.

19. The friction reducer of claim 17, wherein the thickening agent is a biopolymeric thickening agent.

20. The friction reducer of claim 17, wherein the friction reducer does not comprise a viscosifier that is not the thickening agent.
